(19) United States
(12) Patent Application Publication
(10) Pub. No.: US 2024/0269718 A1
(43) Pub. Date: Aug. 15, 2024

(54) SYSTEMS AND METHODS FOR REMOVAL OF CONTAMINANTS

(71) Applicant: Chevron U.S.A. Inc., San Ramon, CA (US)

(72) Inventors: Janelle Lee Lewis, Spring, TX (US); Adam James Dassey, Houston, TX (US)

(21) Appl. No.: 18/166,886

(22) Filed: Feb. 9, 2023

(51) Int. Cl. B08B 7/00; B08B 5/04; B08B 7/04; B08B 9/043; B08B 13/00

(52) U.S. Cl. CPC B08B 7/0042; B08B 5/04; B08B 7/04; B08B 9/043; B08B 13/00; B08B 2209/04

(57) ABSTRACT

The present embodiments provide systems for cleaning NORM scale or other contaminants off of one or more objects via a laser. The laser can be moved through a pipe or around one more containers. This avoids the use of water to remove NORM, thus the present systems are more environmentally friendly than conventional cleaning systems.

### FIELD OF THE DISCLOSURE

The present disclosure relates generally to a system and method for removing contaminants from one or more objects including pipes.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Equipment such as pipes, vessels, separators, valves, and flow lines can contact sufficient amounts of produced fluids to accumulate naturally occurring radioactive materials (NORM). Once this equipment is removed from service, the equipment has to be treated to remove the NORM to allow the equipment to be recycled, reused, or disposed in a cost efficient manner. Typically, the NORM is removed by a process where high pressure water or other chemical solvents remove and/or dissolve the NORM away from the equipment. During the removal, there must be safeguards and environmental containment measures in place to contain the generated liquid with dissolved NORM. The resulting mixture is either disposed of, or further treated to recover the NORM from the liquid. Direct disposal without further treatment is not widely available. Further treatment involves precipitating the NORM, and analyzing the treated liquid to confirm sufficient NORM removal to meet applicable standards. The precipitated NORM can then be sent for disposal, and the liquid is either reused for further NORM removal or used for deep well injection. A need exists to avoid the production of liquids with dissolved NORM and the additional processes associated with their treatment.

These and other deficiencies exist. It is now recognized that there is a need to provide systems and methods that overcome these deficiencies.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Aspects of the disclosed embodiments include systems for cleaning contaminants from one or more objects using lasers.

Embodiments of the present disclosure provide a system for the cleaning of a pipe, the system comprising: a laser; a vacuum, wherein the vacuum is positioned near at least one of the open ends; a rail, wherein the rail element is configured to be threaded through the pipe; a mounting element configured to removably mount the laser to the rail, wherein the mounting element is further configured to move along the rail; and a control module, the control module further comprising a processor, wherein the processor is configured to activate the laser, wherein the processor is further configured to move the mounting element on the rail through the pipe towards either of the two open ends, and wherein the processor is further configured to activate the vacuum while the laser is in use.

Embodiments of the present disclosure also provide a system for the cleaning of equipment with a laser, the system comprising: a container comprising at least one open end; a laser; a vacuum; a monitoring element, wherein the monitoring element is configured to allow one or more users to view the inside of the container such that one or more objects in the container can be inspected and the position of the laser can be monitored; a positioning system comprising: a positioning rig, wherein the positioning rig is removably attached near the open end of the container, and a positioning device, wherein the positioning device is configured to move the laser around the positioning rig such that the laser is pointed at one or more objects in the container; a control device, the control module further comprising a processor, wherein the processor is configured to activate the laser, and wherein the processor is configured to activate the vacuum while the laser is in use.

Embodiments of the present disclosure also provide a system or the cleaning of equipment with a laser, the system comprising: a container comprising at least one open end; a laser; a vacuum; a monitoring element, wherein the monitoring element is configured to allow one or more users to view the inside of the container such that one or more objects in the container can be inspected and the position of the laser can be monitored; a positioning system comprising: a positioning rig, wherein the positioning rig is removably attached at the bottom of the container, and a positioning device, wherein the positioning device is configured to move the one or more objects around the positioning rig such that the laser is pointed at the one or more objects in the container; a control device, the control module further comprising a processor, wherein the processor is configured to activate the laser, and wherein the processor is configured to activate the vacuum while the laser is in use.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is a block diagram illustrating a system according to an example embodiment.

FIG. 2 is a block diagram illustrating a system according to an example embodiment.

FIG. 3 is a block diagram illustrating a system according to an example embodiment.

FIG. 4 is a block diagram illustrating a system according to an example embodiment.

FIG. 5 is a block diagram illustrating a system according to an example embodiment.

### DETAILED DESCRIPTION

Example embodiments of the invention will now be described in order to illustrate various features of the invention. The embodiments described herein are not intended to be limiting as to the scope of the invention, but rather are intended to provide examples of the components, use, and operation of the invention.

Furthermore, the described features, advantages, and characteristics of the embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The invention involves a process in which a laser system passes through or over equipment containing NORM scale. The laser system emits a high energy photon beam toward the surface of the equipment. The high energy photon beam imparts heat into the NORM to ablate the NORM from the surface of the equipment. A vacuum system is applied during the laser application to collect and store the removed NORM scale. The removed NORM scale is sent for disposal.

The invention is generally applicable to NORM-impacted equipment that may be stored at NORM storage yards, or NORM-impacted equipment that has recently been removed from service. Alternatively, the invention could be used for equipment in exploration and production service. This invention provides a significant improvement over past or otherwise conventional methods: This inventions avoids the use or water, other liquids, and chemicals in removing the NORM. Thus, users avoid storing or disposing of the NORM-contaminated liquids which can be costly or time-consuming.

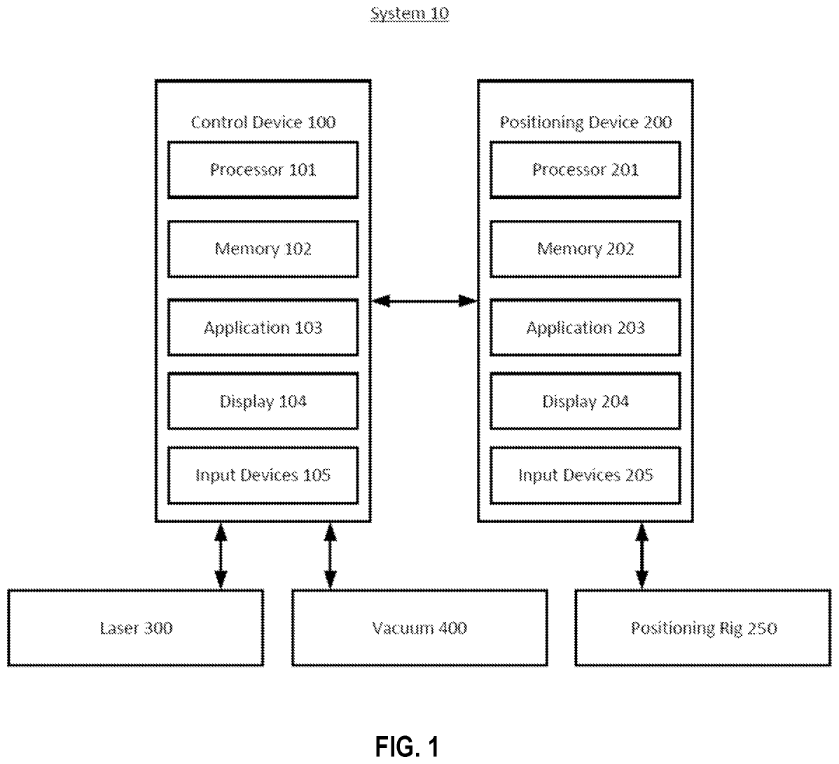

FIG. 1 illustrates a system according to an example embodiment.

The control devices 100 may include a processor 101, a memory 102, and an application 103. The processor 101 may be a processor, a microprocessor, or other processor, and the control devices 100 may include one or more of these processors. The processor 101 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 101 may be coupled to the memory 102. The memory 102 may be a read-only memory, write-once read-multiple memory or read/write memory, e.g., RAM, ROM, and EEPROM, and the control devices 100 may include one or more of these memories. A read-only memory may be factory programmable as read-only or one-time programmable. One-time programmability provides the opportunity to write once then read many times. A write-once read-multiple memory may be programmed at one point in time. Once the memory is programmed, it may not be rewritten, but it may be read many times. A read/write memory may be programmed and re-programed many times after leaving the factory. It may also be read many times. The memory 102 may be configured to store one or more software applications, such as the application 103, and other data.

The application 103 may comprise one or more software applications, such as a mobile application and a web browser, comprising instructions for execution on the control device 100. In some examples, the control device 100 may execute one or more applications, such as software applications, that enable, for example, network communications with one or more components of the system 10, transmit and/or receive data, and perform the functions described herein. Upon execution by the processor 101, the application 103 may provide the functions described in this specification, specifically to execute and perform the steps and functions in the process flows described below. Such processes may be implemented in software, such as software modules, for execution by computers or other machines. The application 103 may provide graphical user interfaces (GUIs) through which a user may view and interact with other components and devices within the system 10. The GUIs may be formatted, for example, as web pages in HyperText Markup Language (HTML), Extensible Markup Language (XML) or in any other suitable form for presentation on a display device depending upon applications used by users to interact with the system 10.

The control device 100 may further include a display 104 and input devices 105. The display 104 may be any type of device for presenting visual information such as a computer monitor, a flat panel display, and a mobile device screen, including liquid crystal displays, light-emitting diode displays, plasma panels, and cathode ray tube displays. The input devices 105 may include any device for entering information into the control device 100 that is available and supported by the control device 100, such as a touch-screen, keyboard, mouse, cursor-control device, touch-screen, microphone, digital camera, video recorder or camcorder. These devices may be used to enter information and interact with the software and other devices described herein.

The system can also include a positioning device 200. The positioning device 200 may include a processor 201, a memory 202, and an application 203. The processor 201 may be a processor, a microprocessor, or other processor, and the positioning devices 200 may include one or more of these processors. The processor 201 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 201 may be coupled to the memory 202. The memory 202 may be a read-only memory, write-once read-multiple memory or read/write memory, e.g., RAM, ROM, and EEPROM, and the control devices 100 may include one or more of these memories. A read-only memory may be factory programmable as read-only or one-time programmable. One-time programmability provides the opportunity to write once then read many times. A write-once read-multiple memory may be programmed at one point in time. Once the memory is programmed, it may not be rewritten, but it may be read many times. A read/write memory may be programmed and re-programed many times after leaving the factory. It may also be read many times. The memory 202 may be configured to store one or more software applications, such as the application 203, and other data.

The application 203 may comprise one or more software applications, such as a mobile application and a web browser, comprising instructions for execution on the control device 100. In some examples, the positioning device 200 may execute one or more applications, such as software applications, that enable, for example, network communications with one or more components of the system 10, transmit and/or receive data, and perform the functions described herein. Upon execution by the processor 201, the application 203 may provide the functions described in this specification, specifically to execute and perform the steps and functions in the process flows described below. Such processes may be implemented in software, such as software modules, for execution by computers or other machines. The application 203 may provide graphical user interfaces (GUIs) through which a user may view and interact with other components and devices within the system 10. The GUIs may be formatted, for example, as web pages in HyperText Markup Language (HTML), Extensible Markup Language (XML) or in any other suitable form for presentation on a display device depending upon applications used by users to interact with the system 10.

The positioning device 200 may further include a display 204 and input devices 205. The display 204 may be any type of device for presenting visual information such as a computer monitor, a flat panel display, and a mobile device screen, including liquid crystal displays, light-emitting diode displays, plasma panels, and cathode ray tube displays. The input devices 205 may include any device for entering information into the positioning device 200 that is available and supported by the positioning device 200, such as a touch-screen, keyboard, mouse, cursor-control device, touch-screen, microphone, digital camera, video recorder or camcorder. These devices may be used to enter information and interact with the software and other devices described herein.

The system can also include a laser 300 capable of performing laser ablation or photoablation, also called laser blasting. The laser 300 can be configured be a pulse laser or continuous wave laser beam. Lasers in the known art may be used in the various embodiments.

The system can include a vacuum 400. Vacuums in the known art may be used in the various embodiments.

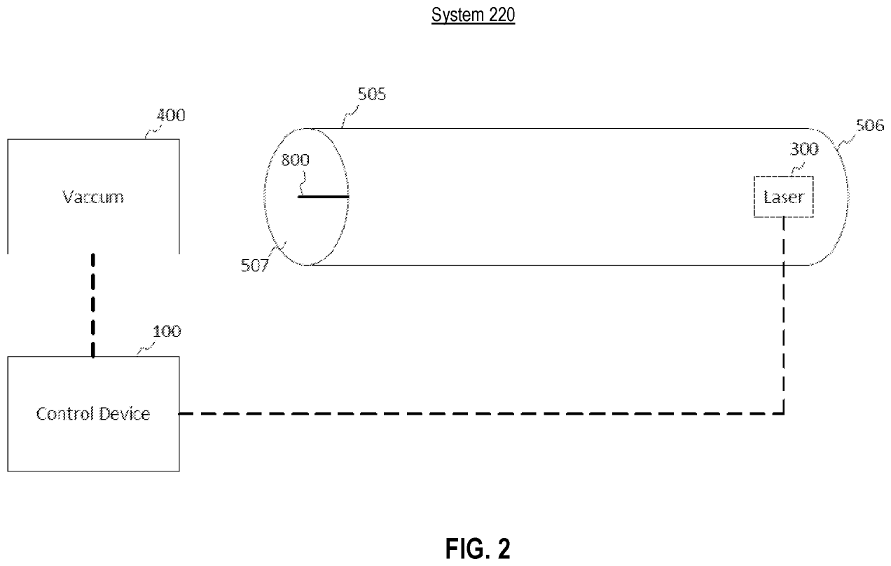

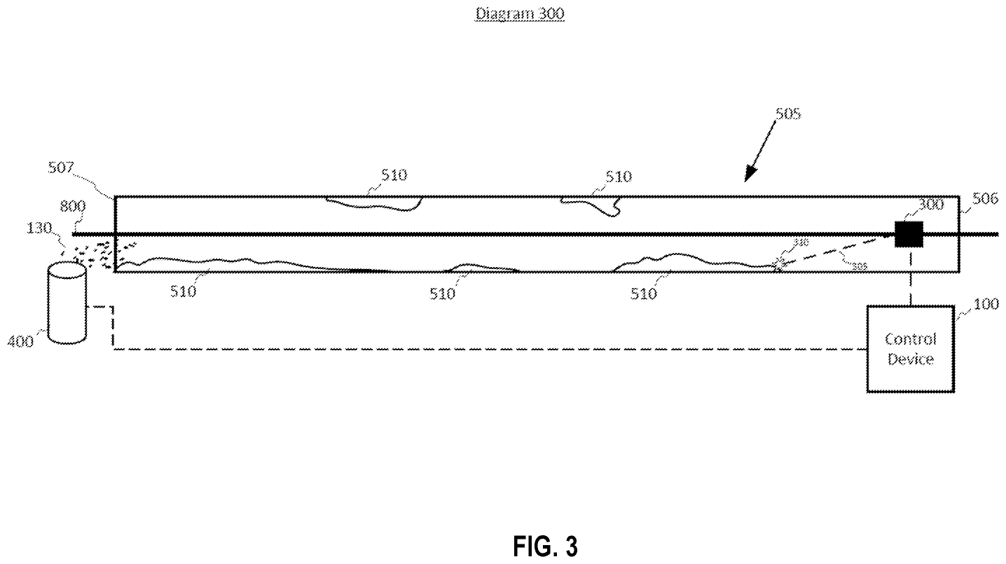

FIG. 2 is a block diagram of a system 220 according to an example embodiment. The system 220 can include a control device 100, laser 300, rail 800, and vacuum 400. The control device 100 and laser 300 are discussed with further reference to FIG. 1. The laser 300 can be mounted onto the rail 800 via a mounting element. The rail can be threaded through the pipe 505 such that the laser 300 can move through the pipe 505. The laser 300 can be operably connected to the control device 100. The vacuum 400 can also be operably attached to the control device 100. FIG. 3 illustrates a cross section of the system 220.

The system 220 can include a pipe 505 of any determined length. The pipe 505 can be, without limitation, a pipe associated with a oil drilling, boring, oil transportation, or other industry in which NORM scale or other contaminants can accumulate within the pipe. Although FIG. 2 and other figures illustrate a pipe, it is understood that the systems and methods described herein can be applied to objects other than pipes, including without limitation vessels, separators, valves, and flow lines. The pipe 505 can include two open ends 506 and 507. In other embodiments, only one open end or more than two open ends can be included. Within the pipe 505, a rail 800 can be threaded through the one or more open ends 506 and 507. Attached to the rail 800 can be one or more lasers 300. In FIG. 2, the laser 300 is understood to be within the pipe 505. Connected to the laser 300 is a control module 100 discussed with further reference to FIG. 1. The control module 100 can be connected to the laser 300 via a wired or wireless connection. The control module 100 can also be connected to one or more vacuums 400 via a wired or wireless connection. The one or more vacuums 400 can be positioned near one of the open ends 507 and 506 of the pipe 505. The control module 100 can, via a processor, activate the vacuum 400 and the laser 300 such that the vacuum 400 can be activated whenever the laser 300 is on. In other embodiments, one or more vacuums 400 can be activated in conjunction or disjunction with one or more lasers 300. Turning to FIG. 3, the control device 100 can activate the laser 300 such that the laser 300 fires or emits a photon beam 305. In other embodiments, other types of lasers can emit other types of beams. The photon beam 305 can hit one or more NORM scale 510 which might be on the inside of the pipe 505. FIG. 3 depicts NORM scale 510 is several places, although it is understood that in other embodiments there be me significantly less or significantly more NORM scale 510 than illustrated. Once the NORM scale 510 is destroyed by the photon beam 305, the one or more vacuums 400 can suck in the debris 130 that is created.

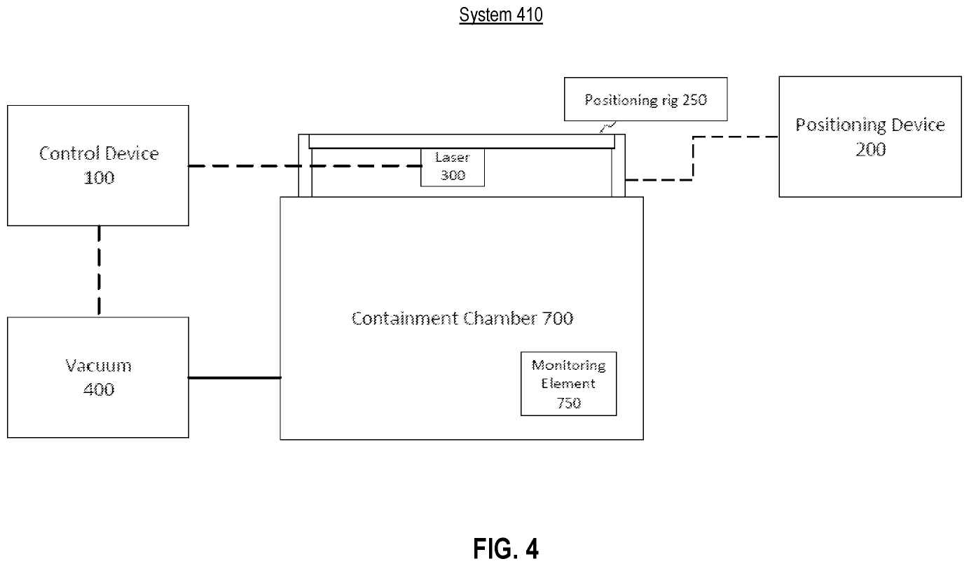

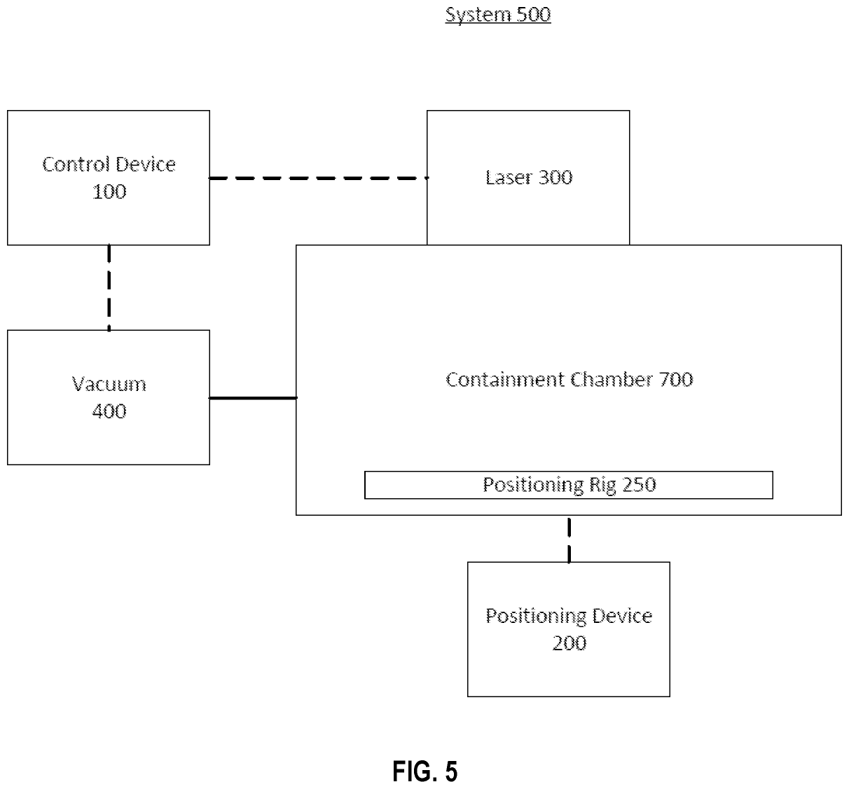

In other embodiments, the object being cleaned may not be a pipe, but some other piece of equipment that cannot be threaded through with a rail. In these examples, the embodiments in FIGS. 4 and 5 may be used.

FIG. 4 depicts a system 410 for cleaning one or more objects with a laser. The system can include a containment chamber 700 which can be configured with one or more openings. Near or on at least one of the openings can be a positioning rig 250. The positioning rig 250 can control the position of one or more lasers 300. The positioning of the laser 300 can be controlled by a positioning device 200 discussed with further reference to FIG. 1. The positioning device 200 can position the laser 300 in two or more dimensions over the opening of the containment chamber 700 such that any objects within the containment chamber 700 can be fired upon by the laser. The system of FIG. 4 can also include a control device 100 which controls the activation of one or more vacuums 400 and one or more lasers 300. The containment chamber 700 can include one or more monitoring elements 750 configured to allow one or more users to view the inside of the containment chamber 700 during or not during use of the laser 300. Thus, the one or more monitoring elements 750 allow one or more users to view the one or more objects within the containment chamber 700 while the objects are being cleaned by the laser 300 and vacuum 400. The containment chamber 700 may contain one or more openings such that these openings may be connected to the vacuum 400 such that the vacuum 400 can clean up any debris left behind by the cleaning.

FIG. 5 illustrates a system with a containment chamber 700 having one or more openings. On the floor or bottom of the containment chamber 700 is a positioned rig 250 configured to removably attach with one or more objects for cleaning. The positioning rig 250 can be controlled by the positioning device 200 such that the positioning device 200 can move around one or more objects via the positioned rig 250 such that the laser 300 can clean the objects with precision.

Although embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes. The invention should therefore not be limited by the above described embodiments, method, and examples, but by all embodiments within the scope and spirit of the invention as claimed.

Further, it is to be understood that the terminology used herein is for the purpose of describing particular embodiments only and is not intended to be limiting. The terms “a” or “an” as used herein, are defined as one or more than one. The term “plurality” as used herein, is defined as two or more than two. The term “another” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

In the invention, various embodiments have been described with references to the accompanying drawings. It may, however, be evident that various modifications and changes may be made thereto, and additional embodiments may be implemented, without departing from the broader scope of the invention as set forth in the claims that follow. The invention and drawings are accordingly to be regarded in an illustrative rather than restrictive sense.

The invention is not to be limited in terms of the particular embodiments described herein, which are intended as illustrations of various aspects. Many modifications and variations can be made without departing from its spirit and scope. Functionally equivalent systems, processes and apparatuses within the scope of the invention, in addition to those enumerated herein, may be apparent from the representative descriptions herein. Such modifications and variations are intended to fall within the scope of the appended claims. The invention is to be limited only by the terms of the appended claims, along with the full scope of equivalents to which such representative claims are entitled.

What is claimed is:

1. A system for the cleaning of a pipe, the system comprising:
a laser;
a vacuum, wherein the vacuum is positioned near at least one of the open ends;
a rail, wherein the rail element is configured to be threaded through the pipe;
a mounting element configured to removably mount the laser to the rail, wherein the mounting element is further configured to move along the rail; and
a control module, the control module further comprising a processor,
wherein the processor is configured to activate the laser,
wherein the processor is further configured to move the mounting element on the rail through the pipe towards either of the two open ends, and
wherein the processor is further configured to activate the vacuum while the laser is in use.

2. A system for the cleaning of equipment with a laser, the system comprising:
a container comprising at least one open end;
a laser;
a vacuum;
a monitoring element, wherein the monitoring element is configured to allow one or more users to view the inside of the container such that one or more objects in the container can be inspected and the position of the laser can be monitored;
a positioning system comprising:
a positioning rig, wherein the positioning rig is removably attached near the open end of the container, and
a positioning device, wherein the positioning device is configured to move the laser around the positioning rig such that the laser is pointed at one or more objects in the container;
a control device, the control module further comprising a processor,
wherein the processor is configured to activate the laser, and
wherein the processor is configured to activate the vacuum while the laser is in use.

3. A system or the cleaning of equipment with a laser, the system comprising:
a container comprising at least one open end;
a laser;
a vacuum;
a monitoring element, wherein the monitoring element is configured to allow one or more users to view the inside of the container such that one or more objects in the container can be inspected and the position of the laser can be monitored;
a positioning system comprising:
a positioning rig, wherein the positioning rig is removably attached at the bottom of the container, and
a positioning device, wherein the positioning device is configured to move the one or more objects around the positioning rig such that the laser is pointed at the one or more objects in the container;
a control device, the control module further comprising a processor,
wherein the processor is configured to activate the laser, and
wherein the processor is configured to activate the vacuum while the laser is in use.
